(19) United States
(12) Patent Application Publication
(10) Pub. No.: US 2025/0264604 A1
(43) Pub. Date: Aug. 21, 2025

(54) RADAR SYSTEM FOR AUTOMOBILE TRACKING

(71) Applicant: MURATA MANUFACTURING CO., LTD., KYOTO (JP)

(72) Inventors: Hassan Daniel Moradi, San Diego, CA (US); Ashish Basireddy, San Diego, CA (US)

(73) Assignee: MURATA MANUFACTURING CO., LTD., KYOTO (JP)

(21) Appl. No.: 19/044,552

(22) Filed: Feb. 3, 2025

Related U.S. Application Data
(60) Provisional application No. 63/556,012, filed on Feb. 21, 2024.

(51) Int. Cl. G01S 13/91; G01S 13/04

(52) U.S. Cl. CPC G01S 13/91; G01S 13/04

(57) ABSTRACT

A radar system comprises a first radar transmitter arranged to transmit a first signal that propagates perpendicular to a direction of travel of a first object and a second object. The radar system further comprises a first radar receiver arranged to receive the first signal. Additionally, the radar system comprises a second radar transmitter spaced apart from the first transmitter and arranged to transmit a second signal that propagates perpendicular to the direction of travel of the first object. The radar system comprises a second radar receiver arranged to receive the second signal. The radar system further comprises a processor arranged to detect a space between the first object and the second object.

### CROSS REFERENCES TO RELATED APPLICATIONS

This application claims priority to U.S. Provisional Patent Application Ser. No. 63/556,012, for “RADAR SYSTEM FOR AUTOMOBILE TRACKING” filed Feb. 21, 2024, which is hereby incorporated by reference in its entirety for all purposes.

### FIELD

The present invention relates generally to radar systems and in particular to the deployment of radar systems to track automobile traffic.

### BACKGROUND

Some entities, such as fast-food restaurants, serve customers using a drive-through order and order fulfillment process. Certain performance parameters such as wait time at the ordering window, time from the ordering window to the pick-up window, time at the pick-up window, total transit time, number of vehicles per unit of time, etc. can be used to evaluate the performance of the drive-through process. Typically, optical instruments, such as cameras or video equipment, can be deployed to monitor drive-through traffic and collect data that can be used to calculate the performance parameters. The optical instruments can be expensive to deploy, can generate erroneous data and may not function reliably in certain weather and/or lighting conditions.

There is a need for improved systems and methods for evaluating drive-through processes. These and other needs are addressed by the present technology.

### SUMMARY OF THE INVENTION

In some embodiments, a radar system includes a first radar transmitter arranged to transmit a first signal that propagates perpendicular to a direction of travel of a first object and a second object. The radar system further includes a first radar receiver arranged to receive the first signal. Additionally, the radar system includes a second radar transmitter spaced apart from the first transmitter and arranged to transmit a second signal that propagates perpendicular to the direction of travel of the first object. The radar system includes a second radar receiver arranged to receive the second signal. The radar system further includes a processor coupled to the first radar transmitter, the first radar receiver, the second radar transmitter, and to the second radar receiver. The processor may include one or more control and/or computing circuits such as for example a system on a chip (SOC) and is arranged to detect a space between the first object and the second object.

In some embodiments, the processor is arranged to use the first signal to detect the space between the first object and the second object. In various embodiments, the processor is arranged to use the second signal to detect the space between the first object and the second object. In some embodiments, the processor is arranged to detect an end of the first object and a beginning of the second object. In various embodiments, the first object is a first vehicle and the second object is a second vehicle.

In some embodiments, the first radar transmitter and the first radar receiver are arranged to create a first radar detection zone and the second radar transmitter and the second radar receiver are arranged to create a second radar detection zone. The first radar detection zone is spaced apart and separate from the second radar detection zone. In various embodiments, the processor is arranged to determine a duration of time the first object remains within the first radar detection zone and a duration of time the second object remains within the second radar detection zone. In some embodiments, the processor is arranged to determine a duration of time from when the first object enters the first radar detection zone and when the first object leaves the second radar detection zone.

In some embodiments, a vehicle tracking system includes a first radar transceiver arranged to generate a first radar detection zone oriented perpendicular to a direction of travel of a series of vehicles. The vehicle tracking system further includes a second radar transceiver arranged to generate a second radar detection zone oriented perpendicular to the direction of travel of the series of vehicles. The second radar detection zone is separate and spaced apart from the first radar detection zone.

In some embodiments, the vehicle tracking system includes a processor arranged to detect a respective space between each vehicle in the series of vehicles while the series of vehicles pass through the first radar detection zone. In various embodiments, the vehicle tracking system further includes a processor arranged to detect a respective space between each vehicle in the series of vehicles while the series of vehicles pass through the second radar detection zone. In some embodiments, the vehicle tracking system further includes a processor arranged to detect a respective space between each vehicle in the series of vehicles. In various embodiments, the processor is arranged to determine a space between each vehicle in the series of vehicles in each of the first and the second radar detection zones. In some embodiments, the processor is arranged to detect an end of a first vehicle in the series of vehicles and to detect a beginning of a second vehicle in the series of vehicles. In various embodiments, the processor of the vehicle tracking system is arranged to determine a duration of time a first vehicle remains within the first radar detection zone and a duration of time the first vehicle remains within the second radar detection zone.

In some embodiments, the processor of the vehicle tracking system is arranged to determine a duration of time from when a first vehicle enters the first radar detection zone and when the first vehicle leaves the second radar detection zone. In various embodiments, the first radar detection zone is positioned adjacent an ordering location and the second radar detection zone is positioned adjacent an order fulfillment location. In some embodiments, the first radar detection zone is oriented 90 degrees relative to the second radar detection zone.

In some embodiments, a method for operating a radar system involves transmitting, using a first transmitter, a first radar signal that propagates perpendicular to a direction of travel of a first object and a second object. The method further involves receiving, using a first receiver, the first radar signal. Additionally, the method involves transmitting, using a second transmitter, a second radar signal that propagates perpendicular to the direction of travel of the first object and the second object. The method involves receiving, using a second receiver, the second radar signal. Additionally, the method involves detecting, using a processor, a space between the first object and the second object.

In some embodiments, the first transmitter and first receiver of the method form a first detection zone. The second transmitter and second receiver of the method form a second detection zone. The first detection zone is spaced apart and separate from the second detection zone.

### BRIEF DESCRIPTION OF THE DRAWINGS

FIG. 1A is a simplified plan-view schematic of a single-lane drive-through environment for deployment of radar devices according to embodiments of the present disclosure;

FIG. 1B is a simplified plan-view schematic of the radar detection zones in the drive-through environment illustrated in FIG. 1A;

FIG. 1C is a simplified timing diagram of the two automobiles shown in FIGS. 1A and 1B traversing through the radar detection zones shown in FIG. 1B;

FIG. 2 is a simplified plan-view schematic of a dual-lane drive-through environment for deployment of a plurality of radar devices according to embodiments of the present disclosure;

FIG. 3 is a simplified schematic of a computing environment that includes deployed radar devices according to embodiments of the present disclosure;

FIG. 4 is a simplified block diagram of an example computing system for radar devices according to embodiments of the present disclosure; and

FIG. 5 is a simplified diagram of a physical radar system that may be used in drive-through environments, according to some embodiments of the present disclosure.

### DETAILED DESCRIPTION

Certain embodiments of the present invention relate to radio detection and ranging (radar) systems for monitoring and analyzing automobile traffic in an environment. The environment can be, for example, an establishment that serves customers using a drive-through or drive-up process. Several radar devices of an integrated radar system can be deployed at various locations within the drive-through process. Each of the radar devices can be weather resistant and can continue to operate under extreme weather conditions, such as heavy rain and/or other forms of heavy precipitation, extreme cold, extreme heat, extreme humidity, different lighting scenarios, etc. The radar devices can be deployed so that an axis of detection for one or more of the radar devices is perpendicular to a direction of travel for automobiles in the drive-through process. Each of the radar devices can detect leading and/or trailing edges of automobiles as the automobiles pass in front of the radar devices. Thus, the radar devices can monitor drive-through traffic by sensing gaps or openings in a queue of vehicles that enter and exit the drive-through process.

Data from the radar devices can be used to analyze and improve performance parameters associated with the drive-through process such as wait time at the ordering window, time from the ordering window to the pick-up window, time at the pick-up window, total transit time, number of vehicles per unit of time, etc. As used herein, the term “radar device” shall mean any suitable type of radar system including a radar transceiver that includes at least one transmit antenna, at least one receive antenna and a local processor and/or control circuit, a multiple-input multiple-output (MIMO) radar system, a phased array radar system, a single aperture radar system, a pulse-type radar system, a digital-based radar system, a coding-based radar system, an imaging radar, a continuous wave-type radar system (both unmodulated and modulated e.g., frequency modulated continuous wave (FMCW) system and phase-modulated continuous-wave (PMCW) that may use any suitable frequency and/or range of frequencies, and the radar device may include any suitable number of transmit and receive antennas and shall include any other suitable type of radar system.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

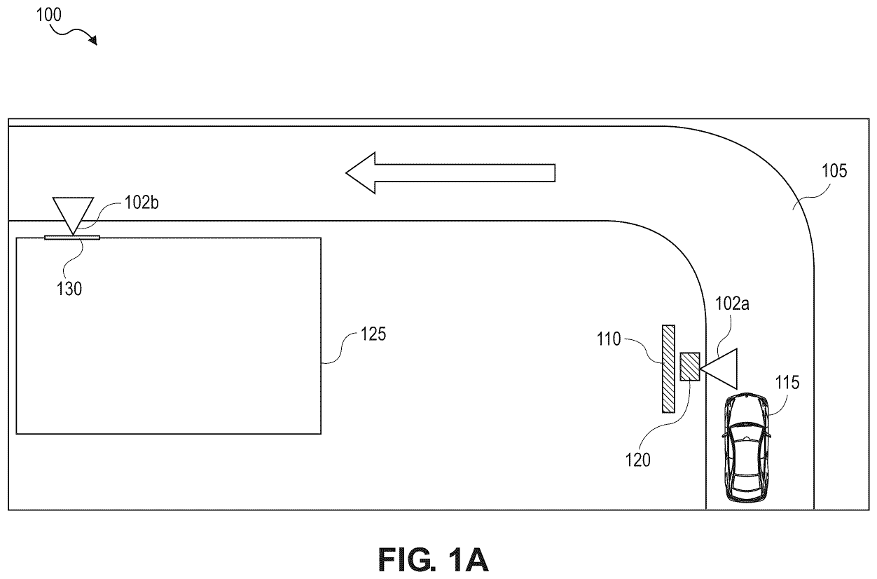

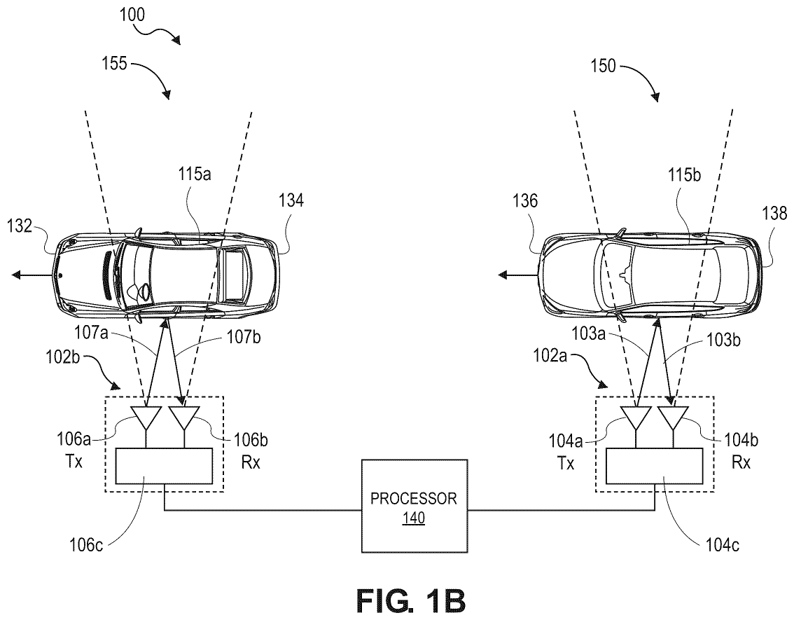

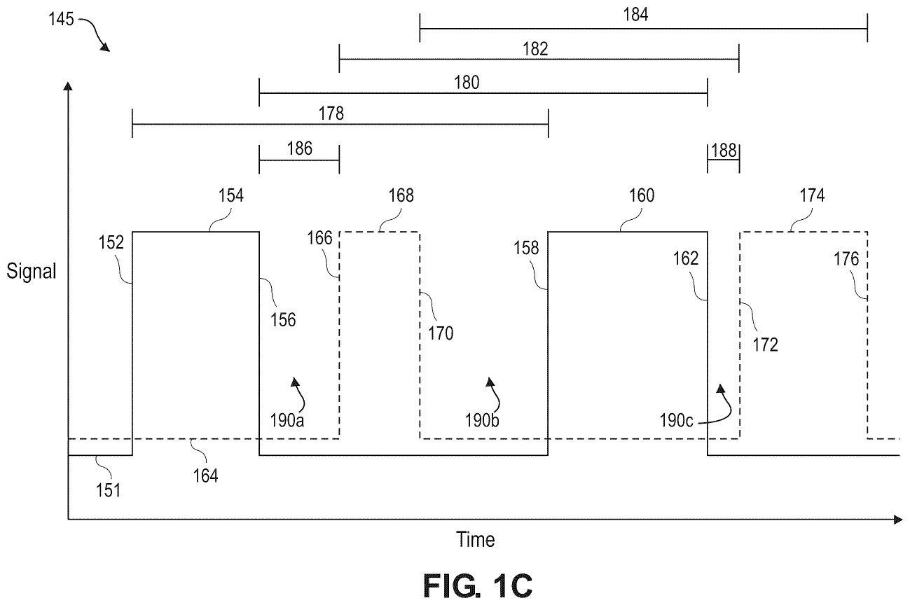

FIG. 1A is a schematic of a drive-through environment 100 that includes first and second radar devices 102a, 102b, respectively, according to some embodiments of the present disclosure. The drive-through environment 100 can include a drive-through lane 105, a menu board 110, a speaker post 120, a customer vehicle 115, and a facility 125 associated with the drive-through environment 100. Examples of the customer vehicle 115 can include cars, trucks, recreation vehicles, three-wheel vehicles, motorcycles, bikes, mopeds, sport utility vehicles, electric vehicles, a walk-up person, etc. The facility 125 can include a drive-through window 130 (e.g., payment and or order fulfillment location). A customer in the customer vehicle 115 can begin a drive-through interaction by pulling up near the speaker post 120, coming to a stop, and selecting products or services by vocally or otherwise choosing the products or services via the speaker post. A list of available products or services can be found on the menu board 110. The customer can then pull the customer vehicle 115 forward along the drive-through lane 105 and stop at the drive-through window 130. The selected products or services can be received by the customer and payment can be made at the drive-through window 130. After receiving the selected products or services, the customer can end the drive-through interaction by driving the customer vehicle 115 past the drive-through window 130 and out of the drive-through lane 105.

First and second radar devices 102a, 102b, respectively, can be deployed in the drive-through environment 100 as shown or in any other suitable configuration. Although two radar devices are shown in FIG. 1, the drive-through environment 100 can include any number of radar devices, including one, three, four, five or more radar devices. First radar device 102a can be deployed proximate the speaker post 120 and second radar device 102b can be deployed proximate the drive-through window. First and second radar devices 102a, 102b, respectively, can each be deployed so that directions of transmission for first and second radar devices are substantially perpendicular to the drive-through lane 105 (e.g., perpendicular to the direction of vehicle motion). Each of first and second radar devices 102a, 102b, can detect a customer vehicle 115, or a gap between customer vehicles, as the customer vehicle 115 passes in front of the respective radar device.

First and second radar devices 102a, 102b, respectively, can detect a leading edge and/or a trailing edge of each customer vehicle 115. First and second radar devices 102a, 102b, respectively, can also record a time that one or both of the leading edge and trailing edge of customer vehicle 115 passes by, thus they can detect a gap between the customer vehicle 115 and a previous vehicle that passed by the respective radar device. Additionally, each of first and second radar devices 102a, 102b, respectively, can detect a second gap between customer vehicle 115 and a next vehicle that passes by the respective radar device. In some embodiments the first gap can be assigned to the previous vehicle and the second gap can be assigned to customer vehicle 115. In further embodiments, the first gap can be assigned to customer vehicle 115 and the second gap can be assigned to the next vehicle. When the first gap is assigned to customer vehicle 115, a total amount of time, tₜₒₜ, that the customer vehicle 115 spends within the drive-through lane 105 can be estimated by an elapsed time between a detection of the first gap by radar device 102a and a detection of the first gap by radar device 102b. Similarly, the time that a leading edge and/or trailing edge of a particular vehicle is detected by first and or second radar devices, 102a, 102b, respectively, can be used to determine the time, tₜₒₜ. First and second radar devices 102a, 102b, respectively, can be used to determine parameters such as wait time at the ordering window, time from the ordering window to the pick-up window, time at the pick-up window, total transit time, a number of vehicles per unit of time, an estimated length of a vehicle, etc.

Each of first and second radar devices 102a, 102b, respectively, can have an orientation that can define an alignment of the direction of transmission each radar device. The directions of alignment of first and second radar devices 102a, 102b, respectively, can be defined by angles of spherical coordinates, including a polar azimuthal angle, θ, and a polar elevation angle, ¢. Each of first and second radar devices 102a, 102b, respectively, can be arranged at an optimal direction of alignment where, for example, the strongest signal and/or most accurate signal is received considering the environment. The optimal direction of alignment can be a direction for a radar detector that either minimizes false positives, false negatives, interference from other radio wave sources (e.g., other radar devices, the environment, etc.) or some combination of the aforementioned. For example, an optimal orientation for radar 102a might be described by angular coordinates (θₒₚₜ^{102a}=0°,ϕₒₚₜ^{102a}=−5°). Such an orientation may point the direction of transmission for first radar device 102a perpendicular to the drive-through lane 105, and also at a slightly downward angle (e.g., −5°) so the radar device 102a can be less likely to detect false positives from vehicles passing by that are just outside the drive-through environment 100.

In other examples, the optimal azimuth angle can be non-perpendicular to the drive-through lane 105, such as slightly askew from perpendicular, for example between 0° to +5°, between −5° to 0°, between −5° to +5°, between 0° to +10°, between −10° to 0° between −10° to +10° between 0° to +20°, between −20° to 0°, between −20° to +20° and other suitable ranges. Additionally, an optimal elevation angle can be oriented with an upward angle or can be 0° while in other embodiments one or more of the radar devices may have an elevation angle between 0° to +5°, between −5° to 0°, between −5° to +5°, between 0° to +10°, between −10° to 0° between −10° to +10° between 0° to +20°, between −20° to 0°, between −20° to +20° and other suitable ranges. An optimal orientation for first radar device 102a can be different than an optimal angle for second radar device 102b. Transmission frequencies and waveforms for first radar device 102a and second radar device 102b can also be different, or may be the same. In some embodiments, instead of one or more of the radar devices being oriented to transmit in-plane with customer vehicle 115, one or more of the radar devices can be oriented to transmit perpendicular to the customer vehicle (e.g., mounted above or below the plane of the customer vehicle). For example, a radar device may be mounted directly above drive-through lane 105 such that a direction of transmission is perpendicular or substantially perpendicular to the ground.

Although first and second radar devices 102a, 102b, respectively, are shown deployed in the drive-through environment 100, the radar devices can be deployed in other, similar environments, such as environments that have locations where a vehicle, person, drone or other object enters and exits an environment. Examples of other suitable environments can include parking garages at an airport, gas stations, electric vehicle charging stations, transportation vehicle warehouses with docking stations, entertainment venue parking lots, border crossings, etc. Further, the drive-through environment 100 disclosed in FIG. 1 is for example only and other environments, configurations, geometries, arrangements and the like are within the scope of this disclosure. As appreciated by one of ordinary skill in the art other suitable arrangements can include a radar absorptive or radar reflective border (e.g., fence) along the outside edge of the drive-through lane 105, along the drive-through lane or at another suitable location which may improve the ability of the radar system to discern between the passage of an automobile within the lane and the passage of an automobile outside the lane, improve the signal to noise ratio of the radar system and the like.

Although first and second radar devices 102a, 102b, respectively, are shown as deployed proximate a speaker post 120 and a drive-through window 130, respectively, one of skill in the art having the benefit of this application will appreciate that the radar devices may be placed at any suitable location and/or orientation. For example, in one embodiment first radar device 102a is positioned approximately 2 meters before the speaker post 120 and second radar device 102b is positioned approximately 1 meter after the drive-through window.

Although first and second radar devices 102a, 102b, respectively, are shown and described as single point reflection radar systems, the embodiments described herein may employ any suitable type of radar system including but not limited to imaging radar systems including those with high resolution.

FIG. 1B is a simplified schematic view of the radar system shown in FIG. 1A that includes first and second radar devices 102a, 102b, respectively. As shown in FIG. 1B, first radar device 102a includes a first transmitter 104a, a first receiver 104b and first controller 104c that work together to create a first detection zone 150, that may also be referred to as a field of view (FOV). Similarly, second radar device 102b includes a second transmitter 106a, a second receiver 106b and a second controller 106c that work together to create a second detection zone 155, that may also be referred to as a FOV. As further shown, first vehicle 115a includes a first front end 132 (where the arrow indicates a direction of travel) and a first trailing end 134. Similarly, second vehicle 115b includes a second front end 136 (where the arrow indicates a direction of travel) and a second trailing end 138. A processor 140 is connected to first transmitter 104a and first receiver 104b through first controller 104c, and it connected to second transmitter 106a and second receiver 106b through second controller 106c. Processor 140 may control the operation of first and second radar devices 102a, 102b, respectively, including the transmission of first and second signals 103a, 107a, respectively, from first and second transmitters 104a, 106a, respectively, and the reception of reflected signals 103b, 107b, respectively, by first and second receivers, 106a, 106b, respectively, via first and second controllers 104c, 106c, respectively.

First receiver 104b may generate first data in response to receiving first reflected signal 103b and second receiver 106b may generate second data in response to receiving second reflected signal 107b. First controller 104c may communicate data related to the first data to processor 140 and similarly second controller 106c may communicate data related to the second data to processor 140. Processor 140 may use both transmit and receive data from first and second radar devices 102a, 102b, respectively, to detect a position of first and second vehicles 115a, 115b, respectively, as described in more detail below. In some embodiments, first transmitter 104a, first receiver 104b and first controller 104c may be collectively referred to as first radar device 102a (e.g., first radar transceiver) and similarly, second transmitter 106a, second receiver 106b and second controller 106c may be collectively referred to as a second radar device 102b (e.g., second radar transceiver).

FIG. 1C is a simplified diagram 145 of example signals generated by the radar system described in FIGS. 1A and 1B as first and second vehicles, 115a and 115b, respectively, pass through first and second detection zones 150, 155, respectively, shown in FIG. 1B. As shown in FIG. 1C a first signal 151 can be generated from data received from first radar device 102a and a second signal 164 can be generated from data received from second radar device 102b. As first vehicle 115a enters first detection zone 150, first front end 132 is detected by first radar device 102a resulting in a first rising edge 152 of first signal 151. As first vehicle 115a departs first detection zone 150, first trailing end 134 of first vehicle 115a is detected by first radar device 102a resulting in a first falling edge 156 of the first signal. A first duration 154 of first vehicle 115a in the first detection zone 150 is a time between first rising edge 152 and first falling edge 156.

As second vehicle 115b enters second detection zone 155, second front end 136 is detected by first radar device 102a resulting in a second rising edge 158 of first signal 151. As second vehicle 115b departs first detection zone 150, second trailing end 138 of second vehicle 115b is detected by first radar device 102a resulting in a second falling edge 162 of the first signal 150. A second duration 160 of second vehicle 115b in the first detection zone 150 is a time between second rising edge 158 and second falling edge 162.

As first vehicle 115a enters second detection zone 155, first front end 132 is detected by second radar device 102b resulting in a fourth rising edge 166 of second signal 164. As first vehicle 115a departs second detection zone 155, first trailing end 134 of first vehicle 115a is detected by second radar device 102b resulting in a third falling edge 170 of the second signal. A third duration 168 of first vehicle 115a in the second detection zone 155 is a time between third rising edge 166 and third falling edge 170.

As second vehicle 115b enters second detection zone 155, second front end 136 is detected by second radar device 102b resulting in a fourth rising edge 172 of second signal 164. As second vehicle 115b departs second detection zone 155, second trailing end 138 of second vehicle 115b is detected by second radar device 102b resulting in a fourth falling edge 176 of the second signal 164. A fourth duration 174 of second vehicle 115b in the second detection zone 155 is a time between fourth rising edge 172 and fourth falling edge 176.

A first duration of time 178 from when first vehicle 115a enters first detection zone 150 and when second vehicle 115b enters the first detection zone can be determined by calculating a difference in time from first leading edge 152 to second leading edge 158. A second duration of time 180 from when first vehicle 115a leaves first detection zone 150 and when second vehicle 115b leaves first detection zone 150 can be determined by calculating a difference in time from first falling edge 156 to second falling edge 162.

A fourth duration of time 182 from when first vehicle 115a enters second detection zone 155 and when second vehicle 115b enters the first detection zone can be determined by calculating a difference in time from third leading edge 166 to fourth leading edge 172. A fourth duration of time 184 from when first vehicle 115a leaves second detection zone 155 and when second vehicle 115b leaves second detection zone 155 can be determined by calculating a difference in time from third falling edge 170 to fourth falling edge 176.

A fifth duration of time 186 from when first vehicle 115a leaves first detection zone 150 and when the first vehicle enters the second detection zone 155 can be determined by calculating a difference in time from first falling edge 156 to third rising edge 166. A sixth duration of time 188 from when second vehicle 115b leaves first detection zone 150 and when the second vehicle enters the second detection zone can be determined by calculating a difference in time from second falling edge 162 to fourth rising edge 172.

One of skill in the art having the benefit of this disclosure will appreciate the many other parameters that can be determined for first vehicle 115a and second vehicle 115b from the radar system described herein, such as, for example, a duration of time from when the first vehicle enters the first detection zone until it leaves the second detection zone, a duration of time from when the second vehicle enters the first detection zone until it leaves the second detection zone, a time that each of the first and second vehicles spend within each of the first and the second detection zones, identification and tracking of each of the first and the second vehicles through the drive-through environment, total transit time of each vehicle, number of vehicles per unit of time, etc. Further, although two vehicles are described with respect to FIGS. 1A-1C, it will be appreciated that the radar system can be used to track any number of vehicles via use of the gaps (e.g., spaces) 190a-190c that identify the end of one vehicle and the beginning of a separate vehicle. The radar system may be used to detect each separate vehicle in a series of vehicles by detecting the gap, or space, between each vehicle in the series of vehicles. In some embodiments more than one radar detector can be used to improve the accuracy of determining the gaps.

It will also be appreciated that the orientation of the first and second detection zones, 150, 155, respectively are approximately 90 degrees, or perpendicular to the direction of travel of the vehicles. Although radar systems generally have an arcuate shaped detection zone (as shown) it may generally be symmetric about a central axis and in this particular embodiment the central axis is perpendicular to the direction of travel of the vehicles.

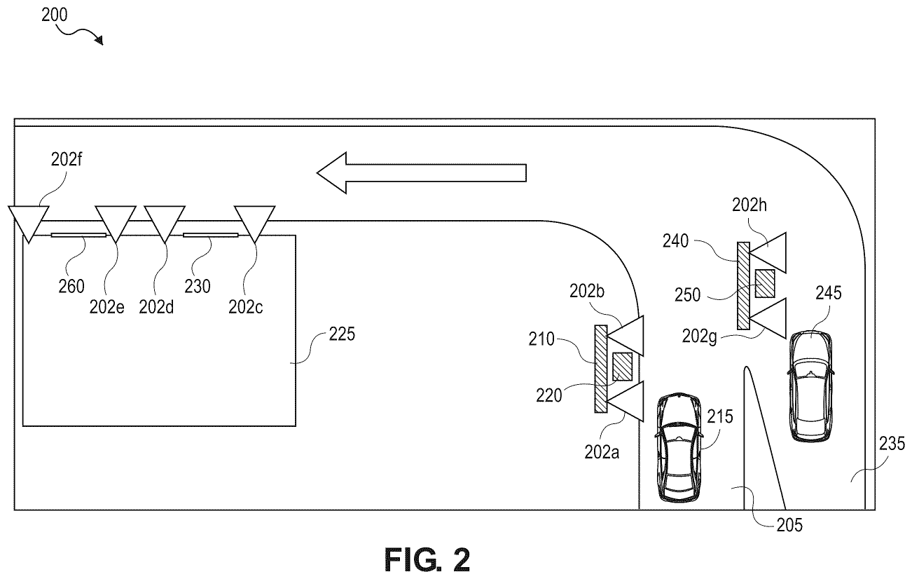

FIG. 2 is a simplified schematic of a drive-through environment 200 for deployment of a plurality of radar devices 202a-h in a dual lane environment, according to certain aspects of the present disclosure. Drive-through environment 200 may be or may include any of the components, features, or characteristics of any of the drive-through environments previously described (e.g., drive-through environment 100), and the features of drive-through environment 200 may be included in the drive-through environments as previously discussed.

The drive-through environment 200 can include a first drive-through lane 205, a first menu board 210, a first speaker post 220, a first customer vehicle 215, a second drive-through lane 235, a second menu board 240, a second speaker post 250, a second customer vehicle 245, and a location 225 associated with the drive-through environment 200. Examples of the first customer vehicle 215 or the second customer vehicle 245 can include cars, trucks, recreation vehicles, three-wheel vehicles, motorcycles, mopeds, sport utility vehicles, electric vehicles, a walk-up person, etc. The facility 225 can include a first drive-through window 230 and a second drive-through window 260. For example, the first drive-through window 230 can complete a payment transaction with a customer and the second drive-through window 260 can provide a customer with goods or services or the first drive-through window may service customers in first lane 205 and second drive-through window may service customers in second lane 235. In some embodiments the first drive-through lane 205 and the second drive-through lane 235 can share a common exit, while in other embodiments they may be serviced by different locations.

A first customer in the first customer vehicle 215 can begin a drive-through interaction by pulling up near the first speaker post 220 of the first drive-through lane 205, coming to a stop, and selecting products or services by vocally or otherwise choosing the products via the first speaker post 220. A list of available products or services can be found on the first menu board 210. The first customer can then pull the first customer vehicle 215 forward along the first drive-through lane 205 and stop at the first drive-through window 230. The first customer can complete a transaction such as a payment transaction and then pull forward to the second drive-through window 260. The selected products or services can be received by the first customer at the second drive-through window 260. After receiving the selected products or services, the first customer can end the drive-through interaction by driving the first customer vehicle 215 past the second drive-through window 260 and out of the first drive-through lane 205.

Similarly, a second customer in the second customer vehicle 245 can begin a drive-through interaction by pulling up near the second speaker post 250 of the second drive-through lane 235, coming to a stop, and selecting products or services by vocally or otherwise choosing the products or services via the second speaker post 250. A list of available products or services can be found on the second menu board 240. The second customer can then pull the second customer vehicle 245 forward along the second drive-through lane 235 and stop at the first drive-through window 230. The second customer can complete a transaction such as a payment transaction and then pull forward to the second drive-through window 260. The selected products or services can be received by the second customer at the second drive-through window 260. After receiving the selected products or services, the second customer can end the drive-through interaction by driving the second customer vehicle 245 past the second drive-through window 260 and out of the second drive-through lane 235.

Radar devices 202a-h (which can each be a radar transceiver or other suitable type of radar system as described above) can be deployed in the drive-through environment 200. Although eight radar devices are shown in FIG. 2, the drive-through environment 200 can include any suitable number of radar devices, including one, two, three, four, five, six, seven, nine, ten or more radar devices. Radar device 202a can be deployed on a first side of the first menu board 210 in front of the first speaker post 220. Radar device 202b can be deployed on a second side of the first menu board 210 after the first speaker post 220. Radar device 202c can be deployed in front of the first drive-through window 230. Radar device 202d can be deployed after the first drive-through window 230. Radar device 202e can be deployed in front of the second drive-through window 260. Radar device 202f can be deployed after the second drive-through window 260. Radar device 202g can be deployed on a first side of the second menu board 240 in front of the second speaker post 250. Radar device 202h can be deployed on a second side of the second menu board 240 after the second speaker post 250. The location of each radar device may vary and other suitable locations for the radar devices are within the scope of this disclosure. Radar devices 202a-h can each be deployed so that directions of transmission for radar devices 202a-h are substantially perpendicular to the first drive-through lane 205 or the second drive-through lane 235. The radar devices 202a-h can be used to detect the first customer vehicle 215, the second customer vehicle 245 or gaps therebetween, as the first and second customer vehicles pass in front of the radar devices 202a-h, as described in more detail below.

More specifically, each of the radar devices 202a-h can detect a passing of a leading edge and/or a trailing edge of the first customer vehicle 215 or the second customer vehicle 245. Each of the radar devices 202a-h can also record a time that the leading edge and/or trailing edge of the first customer vehicle 215 or the second customer vehicle 245 passes by. Thus, each of the radar devices 202a-h can detect a first gap between the first customer vehicle 215 and a previous vehicle that passed by each of the radar devices 202a-h. Additionally, each of the radar devices 202a-h can detect a different gap between the first customer vehicle 215 and a next vehicle that passes by each of the radar devices 202a-h. The first gap can be assigned to the previous vehicle and the different gap can be assigned to the first customer vehicle 215. In some examples, the first gap can be assigned to the first customer vehicle 215 and the different gap can be assigned to the next vehicle.

When the first gap is assigned to the first customer vehicle 215, a total amount of time, t₁ₜₒₜ, that the first customer vehicle 215 spends within the first drive-through lane 205 can be estimated by an elapsed time between a detection of the first gap by radar device 202a and a detection of the first gap by radar device 202f (e.g., t₁ₜₒₜ=t_{1f}−t₁ₐ). Other time intervals associated with the first customer vehicle 215 can also be determined, such as a duration of time spent at the first speaker post 220 (t_1order=t_1b-t_1a), a duration of time spent at the first drive-through window 230 (t_1first=t_1d−t_1c), a duration of time spent at the second drive-through window 260 (t_1 second=t_1f−t_1e), etc.

Similarly, when a second gap is assigned to the second customer vehicle 245, a total amount of time, t₂ₜₒₜ, that the second customer vehicle 245 spends within the second drive-through lane 235 can be estimated by an elapsed time between a detection of the second gap by radar device 202g and a detection of the second gap by radar device 202f (e.g., t₂ₜₒₜ=t_{2f}−t_{2g}). Other time intervals associated with the second customer vehicle 245 can also be determined, such as a time spent at the second speaker post 250 (t_2order=t_2h−t_2g), a time spent at the first drive-through window 230 (t_2first=t_2d−t_2c), a time spent at the second drive-through window 260 (t_2 second=t_2f−t_2e), etc.

Each of the radar devices 202a-h can have an orientation that can define an alignment of the direction of transmission for each of the radar devices 202a-h. The directions of alignment for each of the radar devices 202a-h can be defined by angles of spherical coordinates, including a polar angle, θ, and an azimuthal angle, ¢. Each of the radar devices 202a-h can be arranged at an optimal direction of alignment. The optimal direction of alignment can be a direction for a radar detector that either minimizes false positives, false negatives, interference from other radio wave sources (e.g., other radar devices, the environment, etc.) or some combination of the aforementioned. For example, an optimal orientation for radar 202a might be described by angular coordinates (θₒₚₜ^{102a}=0°, ϕₒₚₜ^{102a}=+5°). Such an orientation may point the direction of transmission for radar device 202a perpendicular to the first drive-through lane 205, and also at a slightly upward angle so the radar device 202a can be less likely to detect false positives from vehicles passing by that are just outside the drive-through environment 200 or from vehicles passing through the second drive-through lane 235. In other examples, the optimal polar angle can be non-perpendicular to the first drive-through lane 205 or the second drive-through lane 235, such as slightly askew from perpendicular. Additionally, an optimal azimuthal angle can be oriented with an upward angle or can be 0°. An optimal orientation for radar device 202a can be different than an optimal angle for any of the other radar devices 202b-h. Transmission frequencies for each of the radar devices 202a-h can also be different.

In some embodiments, an optimal azimuth angle can be non-perpendicular to the drive-through lane 205, 235, such as slightly askew from perpendicular, for example between 0° to +5°, between −5° to 0°, between −5° to +5°, between 0° to +10°, between −10° to 0° between −10° to +10° between 0° to +20°, between −20° to 0°, between −20° to +20° and other suitable ranges. Additionally, an optimal elevation angle can be oriented with an upward angle or can be 0° while in other embodiments one or more of the radar devices may have an elevation angle between 0° to +5°, between −5° to 0°, between −5° to +5°, between 0° to +10°, between −10° to 0° between −10° to +10° between 0° to +20°, between −20° to 0°, between −20° to +20° and other suitable ranges. An optimal orientation for one radar device may be different than an optimal angle for a separate radar device. Transmission frequencies and waveforms for one radar device may be different or may be the same for a separate radar device. In some embodiments, instead of one or more of the radar devices being oriented to transmit in-plane with the customer vehicle, one or more of the radar devices can be oriented to transmit perpendicular to the customer vehicle (e.g., mounted above or below the plane of the customer vehicle). For example, a radar device may be mounted directly above drive-through lane such that a direction of transmission is perpendicular or substantially perpendicular to the ground.

Although the radar devices 202a-h are shown deployed in the drive-through environment 200, the radar devices 202a-h can be deployed in other, similar environments, such as environments that have locations where a vehicle enters and exits an environment. Examples of the similar environments can include parking garages at an airport, gas stations, electric vehicle charging stations, transportation vehicle warehouses with docking stations, entertainment venue parking lots, border crossings, etc. In further embodiments the radar devices may additionally or alternatively be employed in other locations such as, for example, an entrance to one or more of the lanes to determine a waiting time to get to the ordering window and/or a length of the line of automobiles in each lane.

Although the radar devices 202a-h are shown as deployed in particular locations of the drive-through environment 200, one of skill in the art having the benefit of this application will appreciate that the radar devices may be placed at any suitable location and/or orientation.

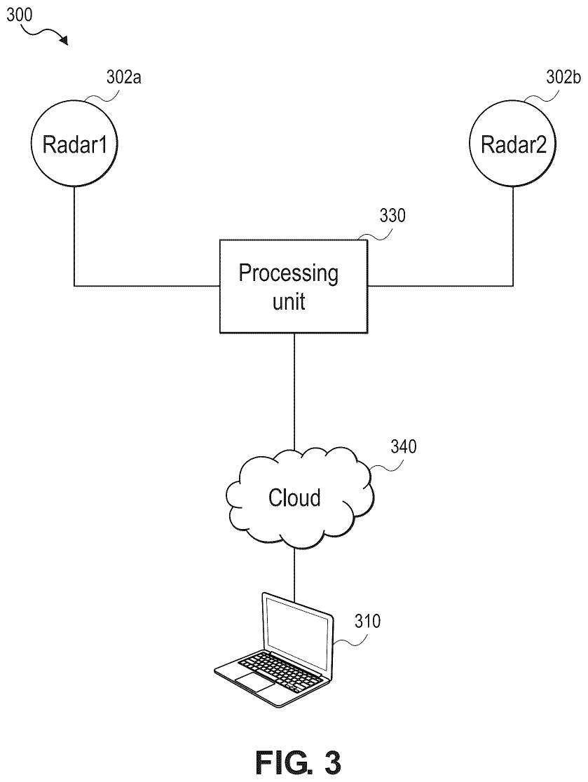

FIG. 3 is a simplified schematic of a computing environment 300 that includes deployed radar devices 302a, b according to certain aspects of the present disclosure. The radar devices 302a, b can be deployed in a drive-through environment, such as drive-through environments 100, 200 from FIGS. 1A-1C and 2. The radar devices 302a, b can be similar to any of the radar devices depicted in FIGS. 1A-1C and 2, such as radar devices 102a, b from FIGS. 1A-1C or any of radar devices 202a-h from FIG. 2. Although two radar devices 202a-h from a single drive-through environment are depicted in FIG. 3, the computing environment 300 can include any number of radar devices and the radar devices can be deployed in any number of drive-through environments or any number of other environments that are similar to drive-through environments. The computing environment 300 can also include a processing unit 330, a cloud 340, and a user device 310, as described in more detail herein.

The processing unit 330 can includes a processor communicatively coupled to a memory. The processor can include one processor or multiple processors. Non-limiting examples of the processor include a Field-Programmable Gate Array (FPGA), an application specific integrated circuit (ASIC), a microprocessor, a personal computer (PC) or any combination of these. The processor can execute instructions stored in the memory to perform operations. In some examples, the instructions stored in the memory can include processor-specific instructions generated by a compiler or an interpreter from code written in any suitable computer-programming language, such as C, C++, C#, or Java.

The memory can include one memory device or multiple memory devices. The memory can be non-volatile and may include any type of memory device that retains stored information when powered off. Non-limiting examples of the memory include electrically erasable and programmable read-only memory (EEPROM), flash memory, or any type of non-volatile memory. At least some of the memory can include a non-transitory computer-readable medium from which the processor can read the instructions. The non-transitory computer-readable medium can include electronic, optical, magnetic, or other storage devices capable of providing the processor with the instructions or other program code. Non-limiting examples of the non-transitory computer-readable medium include magnetic disk(s), memory chip(s), RAM, an ASIC, or any other medium from which a computer processor can read instructions.

The processing unit 330 can be capable of accessing and establishing communications, such as data exchanges, with the deployed radar devices 302a, b. For example, the processing unit 330 can receive data in the form of time stamp data for detected gaps between vehicles and can use the time stamp data to calculate various performance statistics (e.g., traffic rates for each of a plurality of drive-through lanes, average total time that a customer vehicle spends in a drive-through lane, average time that a vehicle spends at a specific component of a drive-through lane, average order time, etc.) for the drive-through environment. The processing unit 330 can calculate the performance statistics in real-time, such as at a time that data is received from the deployed radar devices 302a, b, or within a brief predetermined time interval after the data is received. The processing unit 330 may also be deployed at the drive-through environment or may be at a remote location relative to the drive-through environment.

The performance statistics can be dependent on various parameters. The various parameters can include a location of the drive-through environment, a population density in a vicinity of the drive-through environment, population demographics in the vicinity, a time of day, a day of the week, a holiday season, a particular season of the year, etc. The vicinity can be defined in terms of a radial distance from the drive-through environment. Examples of the radial distance can include a few city blocks, a quarter mile, half a mile, one mile, two miles, five miles, 20 miles, etc. In some examples, the processing unit can use performance statistics from existing drive-through environments to design optimal parameters for future drive-through environments.

The processing unit 330 can share and upload in real time, the data from the deployed radar devices 302a-h and calculated performance statistics with the cloud 340. The cloud 340 can be any cloud computing environment. A user can access the data and calculated performance statistics from the cloud using the user device 310. The user can be, for example, an owner, manager, or employee associated with the drive-through environment. In some examples, authorization can be required before the user can access the data and calculated performance parameters.

As depicted in FIG. 3, the user device 310 can be a laptop or other suitable computer. Examples of the user device can also include mobile devices, including tablet computers, smartphones, and smart watches, which may access the cloud 340 via a Local Area Network (“LAN”) or Wide Area Network (“WAN”), as well as mobile telecommunication networks, short-range wireless networks, or various other communication network types (e.g., cable or satellite networks). Although certain examples herein are described in terms of mobile devices, in other examples, the user device 310 may additionally or alternatively include other mobile or non-mobile devices (e.g., desktop computers, laptop computers, and the like) capable of accessing the cloud 340 via one or more communications networks.

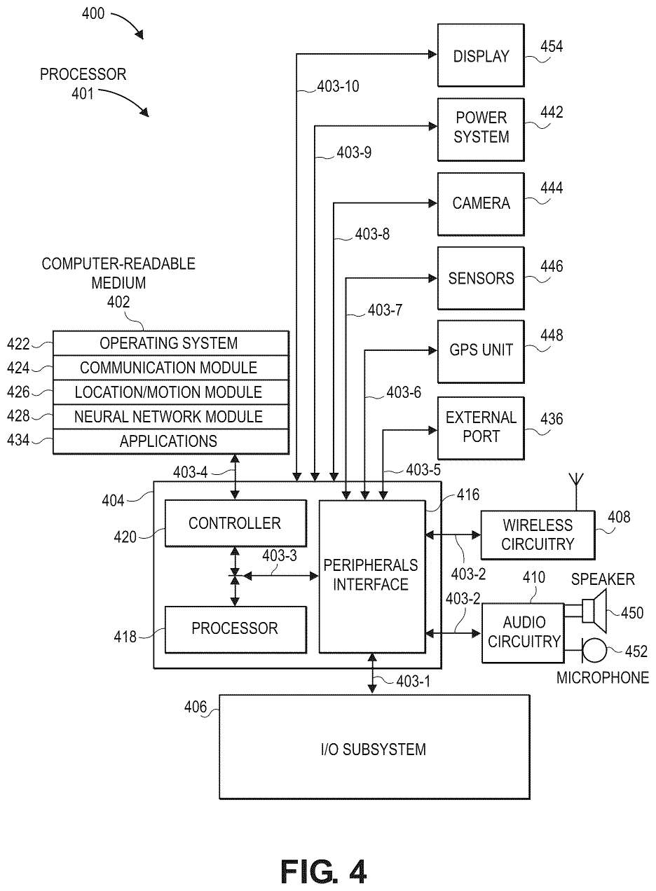

FIG. 4 is a block diagram 400 of an example computing system (e.g. 140 shown in FIG. 1B, 310 and/or 330 shown in FIG. 3) that may be used to operate a radar system as described herein, according to embodiments of the disclosure. Processor 401 may be one or more semiconductor devices including but not limited to a system on a chip (SOC), a multi-chip module, a field programmable gate array (FPGA) or other suitable device. In some embodiments, processor 401 may include a computer-readable medium (memory) 402, a processing system 404, an Input/Output (I/O) subsystem 406, wireless circuitry 408, and audio circuitry 410 including speaker 450 and microphone 452. These components may be coupled by one or more communication buses or signal lines 403. Processor 401 can encompass any suitable processing device and/or portable electronic device, including a handheld computer, a tablet computer, a remote control unit for a drone, a mobile phone, laptop computer, tablet device, media player, a wearable device, personal digital assistant (PDA), a multi-function device, a mobile phone, a portable gaming device, a car display unit, or the like, including a combination of two or more of these items.

The processor 401 can be a multifunction device having a touch screen in accordance with some embodiments. The touch screen optionally displays one or more graphics within user interface (UI). In some embodiments, a user is enabled to select one or more of the graphics by making a gesture on the graphics, for example, with one or more fingers or one or more styluses. In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with processor 401. In some implementations or circumstances, inadvertent contact with a graphic does not select the graphic. For example, a swipe gesture that sweeps over an application icon optionally does not select the corresponding application when the gesture corresponding to selection is a tap. Processor 401 can optionally also include one or more physical buttons, such as “home” or menu button. As menu button is, optionally, used to navigate to any application in a set of applications that are, optionally executed on the processor 401. Alternatively, in some embodiments, the menu button is implemented as a soft key in a graphical user interface displayed on touch screen.

The processor 401 can incorporate a display 454. The display 454 can be a LCD, OLED, AMOLED, Super AMOLED, TFT, IPS, or TFT-LCD that typically can be found a computing device. The display 454 may be a touch screen display of a computing device.

In one embodiment, processor 401 includes touch screen, menu button, push button for powering the device on/off and locking the device, volume adjustment button(s), Subscriber Identity Module (SIM) card slot, head set jack, and docking/charging external port. Push button is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, processor 401 also accepts verbal input for activation or deactivation of some functions through microphone. Processor 401 also, optionally, includes one or more contact intensity sensors for detecting intensity of contacts on touch screen and/or one or more tactile output generators for generating tactile outputs for a user of processor 401.

In one illustrative configuration, processor 401 may include at least one computer-readable medium (memory) 402 and one or more processing units (or processor(s)) 418. Processor(s) 418 may be implemented as appropriate in hardware, software, or combinations thereof. Computer-executable instruction or firmware implementations of processor(s) 418 may include computer-executable instructions written in any suitable programming language to perform the various functions described.

Computer-readable medium (memory) 402 may store program instructions that are loadable and executable on processor(s) 418, as well as data generated during the execution of these programs. Depending on the configuration and type of processor 401, memory 402 may be volatile (such as random access memory (RAM)) and/or non-volatile (such as read-only memory (ROM), flash memory, etc.). Processor 401 can have one or more memories. Processor 401 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the devices. In some implementations, memory 402 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

Memory 402 and additional storage, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. Memory 402 and additional storage are both examples of non-transitory computer storage media. Additional types of computer storage media that may be present in processor 801 may include, but are not limited to, phase-change RAM (PRAM), SRAM, DRAM, RAM, ROM, electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by processor 801. Combinations of any of the above should also be included within the scope of non-transitory computer-readable storage media. Based on the disclosure and teachings provided herein, a person of ordinary skill in the art can appreciate other ways and/or methods to implement the various embodiments. However, as noted above, computer-readable storage media does not include transitory media such as carrier waves or the like.

Alternatively, computer-readable communication media may include computer-readable instructions, program modules, or other data transmitted within a data signal, such as a carrier wave, or other transmission. However, as used herein, computer-readable storage media does not include computer-readable communication media.

Processor 401 may also contain communications connection(s) 408 that allow processor 401 to communicate with a data store, another device or server, user terminals and/or other devices via one or more networks. Such networks may include any one or a combination of many different types of networks, such as cable networks, the Internet, wireless networks, cellular networks, satellite networks, other private and/or public networks, or any combination thereof. Processor 401 may also include I/O device(s) 406, such as a touch input device, a keyboard, a mouse, a pen, a voice input device, a display, a speaker, a printer, etc.

It should be apparent that the architecture shown in FIG. 8 is only one example of an architecture for processor 401, and that processor 401 can have more or fewer components than shown, or a different configuration of components. The various components shown in FIG. 8 can be implemented in hardware, software, or a combination of both hardware and software, including one or more signal processing and/or application specific integrated circuits.

Wireless circuitry 408 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 408 can use various protocols, e.g., as described herein. For example, wireless circuitry 408 can have one component for one wireless protocol (e.g., Bluetooth®) and a separate component for another wireless protocol (e.g., UWB). Different antennas can be used for the different protocols.

Wireless circuitry 408 is coupled to processing system 404 via peripherals interface 416. Interface 416 can include conventional components for establishing and maintaining communication between peripherals and processing system 404. Voice and data information received by wireless circuitry 408 (e.g., in speech recognition or voice command applications) is sent to one or more processors 418 via peripherals interface 416. One or more processors 418 are configurable to process various data formats for one or more application programs 434 stored on computer-readable medium (memory) 402.

Peripherals interface 416 couple the input and output peripherals of the device to processor(s) 418 and computer-readable medium 402. One or more processors 418 communicate with computer-readable medium 402 via a controller 420. Computer-readable medium 402 can be any device or medium that can store code and/or data for use by one or more processors 418. Medium 402 can include a memory hierarchy, including cache, main memory, and secondary memory.

Processor 401 also includes a power system 442 for powering the various hardware components. Power system 442 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management, and distribution of power in mobile devices.

In some embodiments, processor 401 includes a camera 444. In some embodiments, processor 401 includes sensors 446. Sensors 446 can include accelerometers, compasses, gyrometers, pressure sensors, audio sensors, light sensors, barometers, and the like. Sensors 446 can be used to sense location aspects, such as auditory or light signatures of a location.

In some embodiments, processor 401 can include a GPS receiver, sometimes referred to as a GPS unit 448. A mobile device can use a satellite navigation system, such as the Global Positioning System (GPS), to obtain position information, timing information, altitude, or other navigation information, including for one or more objects detected by the radar system. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 418 run various software components stored in medium 402 to perform various functions for processor 401. In some embodiments, the software components include an operating system 422, a communication module (or set of instructions) 424, a location module (or set of instructions) 426, a bounding path 428 that is used as part of ranging operation described herein, and other applications (or set of instructions) 434.

Operating system 422 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components. An operating system 422 is system software that manages computer hardware and software resources and provides common services for computer programs. For example, the operating system 422 can manage the interaction between the user interface module and one or more user application(s). The various embodiments further can be implemented in a wide variety of operating environments, which in some cases can include one or more user computers, devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Communication module 424 facilitates communication with other devices over one or more external ports 436 or via wireless circuitry 408 and includes various software components for handling data received from wireless circuitry 408 and/or external port 436. External port 436 (e.g., USB, FireWire, Lightning connector, 60-pin connector, etc.) is adapted for coupling directly to other devices or indirectly over a network (e.g., the Internet, wireless LAN, etc.).

Location/motion module 426 can assist in determining the current position (e.g., coordinates or other geographic location identifiers) and motion of processor 401 and/or one or more object detected by the radar system. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 826 receives data from GPS unit 448 and analyzes the signals to determine the current position of the mobile device. In some embodiments, location/motion module 426 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 408 and is passed to location/motion module 426. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for processor 401 based on the position coordinates of the corresponding transmitters. Regardless of the specific location technology used, location/motion module 426 receives information from which a location fix can be derived, interprets that information, and returns location information, such as geographic coordinates, latitude/longitude, or other location fix data.

The neural network module 428 can be employed with sparse antennas and used to transform the radar system from a discrete-time signal to a continuous-time signal within the network architecture. In some embodiments the network may be based on a Tensorflow Processing Units (TPU) approach that utilizes sparse antennas in conjunction with the neural network. The neural network can be trained based on generative machine learning generative model based on other based on perception, including Deep Neural Networks (DNN) and convolutional neural network (CNN). In some embodiments the neural network may undergo training to understand patterns and correlations within the available radar data, enabling the network to estimate the signals for the extrapolated antennas that are missing in the array.

The one or more applications programs 434 on the mobile device can include any applications installed on the processor 401, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations and the like) on a display surface. In another example, a timer module can be a software timer. The timer module can also be implemented in hardware. The time module can maintain various timers for any number of events.

The I/O subsystem 406 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 806 can include a display and user input devices such as a keyboard, mouse, and/or track pad. In some embodiments, I/O subsystem 806 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 402) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, processor 801 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art can appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically can include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other devices such as network input/output devices may be employed.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

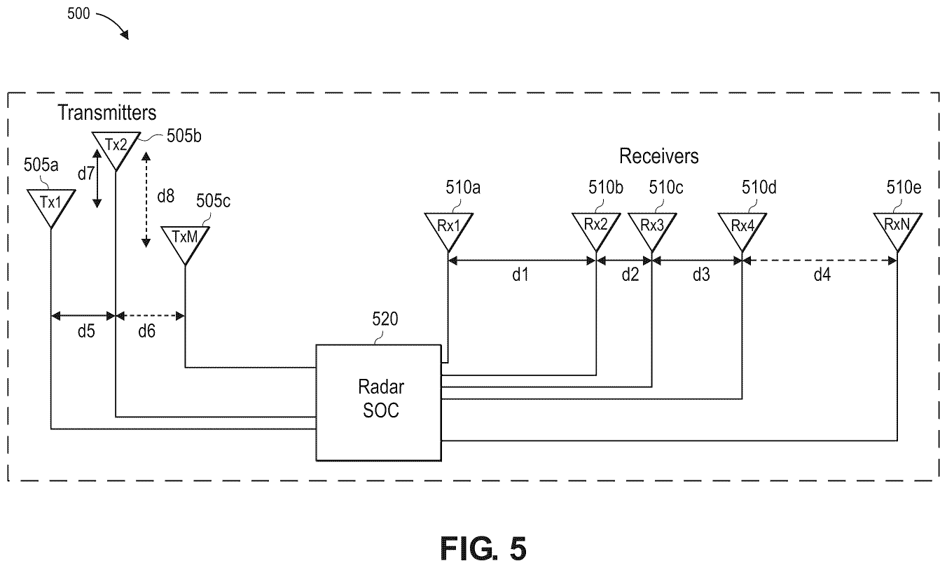

FIG. 5 is a simplified diagram of a physical radar system 500 that may be used in drive-through environments 100, 200 from FIGS. 1A-1C and 2, in computing environment 300 of FIG. 3 and/or in computing environment 400 of FIG. 4, according to some aspects of the present disclosure. Radar system 500 may be or include any of the components, features, or characteristics of any of the radar systems previously described in the present disclosure. More specifically, physical radar system 500 may be used in drive-through environments 100, 200 and in computing environment 300 to provide both azimuth and elevation data. As shown in FIG. 5, the radar system 500 includes three physical transmit antennas 505 where Tx1 505a and Tx2 505b are separated in a horizontal direction by d5 and separated in a vertical direction by d7 and where Tx2 505b and Tx3 505c are separated in the horizontal direction by d6 and in the vertical direction by d8. The third physical transmit antenna TxM 505c indicates that the radar system can include M total (e.g., any suitable number of) physical transmit antennas. While M is three in FIG. 5, M can have any suitable value. While M3 is five in FIG. 5, M can be any suitable value, including N.

Additionally, the radar system 500 depicted in FIG. 5 includes five physical receive antennas where Rx1 510a is separated from Rx2 510b by d1, Rx3 510c separated from Rx2 510b by d2 and Rx4 510d is separated from Rx3 510c by d3. The fifth physical receive antenna RxN 510e is separated from Rx4 510d by d4 and indicates that the radar system can include N total (e.g., any suitable number of) physical receive antennas. While N is five in FIG. 5, N can be any suitable value, including M. The spacings d1-d8 can be any suitable spacing including where one or more of the spacings is one-half the transmission wavelength and where none of the spacings are one-half the transmission wavelength.

Each physical transmit antenna 505 and receive antenna 510 is connected to a processor 520 that controls each antenna and may more specifically control the transmission operations of the transmit antennas and the received data from the receive antennas. The processor 520 may be or include any of the components, features, or characteristics of any of the processors previously described in the present disclosure. Processor 520 may be any suitable processing system including but not limited to a system on a chip (SOC), a local and/or remote computing system or a combination of computing systems. The processor 520 can include a machine learning model. The machine learning model can receive data from and associated with the radar system 500 to produce data for a virtual array of receive antennas.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

1. A radar system comprising:
a first radar transmitter arranged to transmit a first signal that propagates perpendicular to a direction of travel of first and second objects;
a first radar receiver arranged to generate first data in response to receiving a first reflected signal corresponding to the first signal;
a second radar transmitter spaced apart from the first radar transmitter and arranged to transmit a second signal;
a second radar receiver arranged to generate second data in response to receiving a second reflected signal; and
a processor arranged to detect a space between the first object and the second object based on the first data and the second data.

2. The radar system of claim 1, wherein the processor is arranged to use the first data to detect the space between the first object and the second object.

3. The radar system of claim 1, wherein the processor is arranged to use the second data to detect the space between the first object and the second object.

4. The radar system of claim 1, wherein the processor is arranged to detect an end of the first object and a beginning of the second object.

5. The radar system of claim 1, wherein the first object is a first vehicle and the second object is a second vehicle.

6. The radar system of claim 1, wherein the first radar transmitter and the first radar receiver are arranged to create a first radar detection zone and wherein the second radar transmitter and the second radar receiver are arranged to create a second radar detection zone, and wherein the first radar detection zone is spaced apart and separate from the second radar detection zone.

7. The radar system of claim 6, wherein the processor is arranged to determine a duration of time the first object remains within the first radar detection zone and a duration of time the second object remains within the second radar detection zone.

8. The radar system of claim 6, wherein the processor is arranged to determine a duration of time from when the first object enters the first radar detection zone to when the first object leaves the second radar detection zone.

9. A vehicle tracking system comprising:
a first radar transceiver arranged to generate a first radar detection zone oriented perpendicular to a direction of travel of a series of vehicles; and
a second radar transceiver arranged to generate a second radar detection zone, wherein the second radar detection zone is separate from and spaced apart from the first radar detection zone.

10. The vehicle tracking system of claim 9, further comprising a processor arranged to detect a respective space between each vehicle in the series of vehicles while the series of vehicles pass through the first radar detection zone.

11. The vehicle tracking system of claim 9, further comprising a processor arranged to detect a respective space between each vehicle in the series of vehicles while the series of vehicles pass through the second radar detection zone.

12. The vehicle tracking system of claim 9, further comprising a processor arranged to detect a respective space between each vehicle in the series of vehicles.

13. The vehicle tracking system of claim 12, wherein the processor is arranged to determine a space between each vehicle in the series of vehicles in each of the first and the second radar detection zones.

14. The vehicle tracking system of claim 12, wherein the processor is arranged to detect an end of a first vehicle in the series of vehicles and to detect a beginning of a second vehicle in the series of vehicles.

15. The vehicle tracking system of claim 12, wherein the processor is arranged to determine a duration of time a first vehicle remains within the first radar detection zone and a duration of time the first vehicle remains within the second radar detection zone.

16. The vehicle tracking system of claim 12, wherein the processor is arranged to determine a duration of time from when a first vehicle enters the first radar detection zone and when the first vehicle leaves the second radar detection zone.

17. The vehicle tracking system of claim 9, wherein the first radar detection zone is positioned adjacent an ordering location and wherein the second radar detection zone is positioned adjacent an order fulfillment location.

18. The vehicle tracking system of claim 9 wherein the first radar detection zone is oriented 90 degrees relative to the second radar detection zone.

19. A method of operating a radar system, the method comprising:
transmitting, using a first transmitter, a first radar signal that propagates perpendicular to a direction of travel of first and second objects;
receiving, using a first receiver, a first reflected signal corresponding to first radar signal;
transmitting, using a second transmitter, a second radar signal;
receiving, using a second receiver, a second reflected signal corresponding to the second radar signal; and
detecting, using a processor, a space between the first object and the second object.

20. The method of claim 19 wherein the first transmitter and the first receiver form a first detection zone, wherein the second transmitter and the second receiver form a second detection zone, and wherein the first detection zone is spaced apart and separate from the second detection zone.
